(19) United States
(12) Patent Application Publication
(10) Pub. No.: US 2026/0023706 A1
(43) Pub. Date: Jan. 22, 2026

(54) FIELD-PROGRAMMABLE GATE ARRAY STRUCTURE FOR IMPLEMENTING OUT-OF-BAND BRDIGING, OUT-OF-BAND BRIDGING SYSTEM AND METHOD, AND SERVER

(71) Applicants: Guangzhou Panyu Technology Co., Ltd., Guangzhou City (CN); Beijing Baidu Netcom Science Technology Co., Ltd., Beijing (CN)

(72) Inventors: Xianquan Mai, Guangzhou City (CN); Guang Zhou, Guangzhou City (CN)

(21) Appl. No.: 19/242,408

(22) Filed: Jun. 18, 2025

(30) Foreign Application Priority Data
Jul. 19, 2024 (CN) 202410980832.8

(51) Int. Cl. G06F 13/40

(52) U.S. Cl. CPC G06F 13/4027; G06F 2213/40

(57) ABSTRACT

Provided are a field-programmable gate array structure for implementing out-of-band bridging, an out-of-band bridging system and method, and a server, relating to the field of computer technology, especially a server. The field-programmable gate array structure includes at least two first data interface modules, at least two second data interface modules, and a buffer module. Each first data interface module is matched to a respective in-band data interface module. Each second data interface module is matched to a respective management data interface module. The buffer module is configured to buffer data of the first data interface modules and data of the second data interface modules. Each second data interface module is configured to perform data transmission with at least two first data interface modules through the buffer module.

### CROSS-REFERENCE TO RELATED APPLICATION

This application claims priority to Chinese Patent Application No. CN202410980832.8, filed on Jul. 19, 2024, the disclosure of which is incorporated herein by reference in its entirety.

### TECHNICAL FIELD

This disclosure relates to the field of computer technology, especially the field of servers, particularly a field-programmable gate array structure for implementing out-of-band bridging, an out-of-band bridging system and method, and a server.

### BACKGROUND

With the increasing demand for system-on-chip (SoC) array servers (hereinafter referred to as SoC array servers), the market is placing higher requirements on SoC array servers not only in terms of high density and high performance but also in terms of integration of various out-of-band management functions to ensure better operation and maintenance. As a bridge between an in-band part and an out-of-band management controller, an out-of-band bridging system plays an important role in implementing the function of out-of-band management.

### SUMMARY

This disclosure provides a field-programmable gate array structure for implementing out-of-band bridging, an out-of-band bridging system and method, and a server.

According to an aspect of this disclosure, a field-programmable gate array structure for implementing out-of-band bridging is provided. The field-programmable gate array structure includes at least two first data interface modules, at least two second data interface modules, and a buffer module. Each first data interface module is matched to a respective in-band data interface module. Each second data interface module is matched to a respective management data interface module. The buffer module is configured to buffer data of the first data interface modules and data of the second data interface modules. Each second data interface module is configured to perform data transmission with at least two first data interface modules through the buffer module.

According to another aspect of this disclosure, an out-of-band bridging system is provided. The out-of-band bridging system includes at least two field-programmable gate array structures of any embodiment of this disclosure.

According to another aspect of this disclosure, an array server is provided. The array server includes a management controller, the field-programmable gate array structure of any embodiment of this disclosure, and at least two computing units.

The field-programmable gate array structure is configured to bridge the management controller and the at least two computing units.

According to another aspect of this disclosure, a method for implementing out-of-band bridging in a field-programmable gate array structure is provided. The method includes that at least two first data interface modules perform data transmission with an in-band data interface module; multiple second data interface module perform data transmission with a management data interface module; and a buffer module buffers data of the first data interface modules and data of the second data interface modules, where each of the second data interface modules is configured to perform data transmission with the at least two first data interface modules through the buffer module.

It is to be understood that the content described in this part is neither intended to identify key or important features of embodiments of this disclosure nor intended to limit the scope of this disclosure. Other features of this disclosure are apparent from the description provided hereinafter.

### BRIEF DESCRIPTION OF DRAWINGS

The drawings are intended to provide a better understanding of the solutions and not to limit this disclosure.

FIG. 1 is a diagram illustrating the functional structure of an FPGA structure for implementing out-of-band bridging according to an embodiment of this disclosure.

FIG. 2 is a diagram illustrating the functional structure of an FPGA structure for implementing out-of-band bridging according to an embodiment of this disclosure.

FIG. 3 is a diagram illustrating the functional structure of an FPGA structure for implementing out-of-band bridging according to an embodiment of this disclosure.

FIG. 4 is a diagram illustrating the structure of an array server according to an embodiment of this disclosure.

FIG. 5 is a diagram illustrating the structure of an array server according to an embodiment of this disclosure.

FIG. 6 is a flowchart of a method for implementing out-of-band bridging in an FPGA structure according to an embodiment of this disclosure.

FIG. 7 is a flowchart of a method for implementing out-of-band bridging in an FPGA structure according to an embodiment of this disclosure.

FIG. 8 is a flowchart of a method for implementing out-of-band bridging in an FPGA structure according to an embodiment of this disclosure.

### DETAILED DESCRIPTION

Example embodiments of this disclosure, including details of embodiments of this disclosure, are described hereinafter in conjunction with the drawings to facilitate understanding. The example embodiments are illustrative only. Therefore, it is to be appreciated by those of ordinary skill in the art that various changes and modifications may be made to the embodiments described herein without departing from the scope and spirit of this disclosure. Similarly, description of well-known functions and constructions is omitted hereinafter for clarity and conciseness.

An embodiment of this disclosure provides a field-programmable gate array structure for implementing out-of-band bridging. A field-programmable gate array (FPGA) is a development based on programmable devices such as Programmable Array Logic (PAL) and Generic Array Logic (GAL). An FPGA emerged as a type of semi-custom circuit in the field of application-specific integrated circuit (ASIC), not only addressing the shortcomings of custom circuits but also overcoming the limitation of the number of logic gates in existing programmable devices. An FPGA uses the concept of a logic unit array (or gate array) and includes multiple internal logic units and interconnectors. Based on configuration of the values of the logic units, the logic functions of the modules composed of the logic units and the interconnections between the modules can be determined, and thus the functionality achieved by the FPGA can be determined. The main challenge in FPGA design lies in being familiar with the hardware system and internal resources and being able to achieve effective coordination between modules.

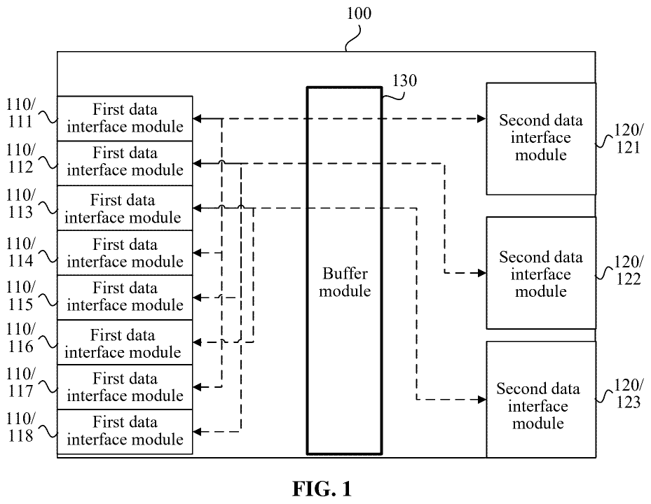

FIG. 1 is a diagram illustrating the functional structure of an FPGA structure for implementing out-of-band bridging according to an embodiment of this disclosure. Referring to FIG. 1, the FPGA 100 includes at least two first data interface modules 110, at least two second data interface modules 120, and a buffer module 130. Each first data interface module 110 is matched to a respective in-band data interface module (not shown in FIG. 1). Each second data interface module 120 is matched to a respective management data interface module (not shown in FIG. 1). The buffer module 130 is configured to buffer data of the first data interface modules 110 and data of the second data interface modules 120. Each second data interface module 120 performs data transmission with at least two first data interface modules 110 through the buffer module 130.

The in-band data interface module is a data interface of an in-band part of a server. By way of example, the in-band part includes a computing unit and a switch unit. The in-band data interface module of this disclosure is particularly applicable to system-on-chip (SoC) array servers and other array servers having the same architecture as SoC array servers. The management data interface module serves as a data interface of a management controller. The management controller is configured to implement management of system information of the in-band computing unit, real-time serial port control, and firmware updates. By way of example, the management controller is a baseboard management controller (BMC).

In this embodiment of this disclosure, the FPGA is provided with first data interface modules 110 matched to in-band data interface modules, second data interface modules 120 matched to management data interface modules, and a buffer module 130 configured to buffer data of the first data interface modules 110 and data of the second data interface modules 120 such that at least two first data interface modules 110 transmit data to the second data interface modules 120 after being buffered by the buffer module 130, thereby enabling the FPGA to implement the function of out-of-band bridging.

Generally, the number of computing units in the in-band part is relatively large. Therefore, the number of in-band data interface modules is greater than the number of management data interface modules.

Referring to FIG. 1, in some embodiments, the at least two first data interface modules 110 include a first data interface module 111, a first data interface module 112, a first data interface module 113, a first data interface module 114, a first data interface module 115, a first data interface module 116, a first data interface module 117, and a first data interface module 118; and the at least two second data interface modules 120 include a second data interface module 121, a second data interface module 122, and a second data interface module 123. The first data interface module 111, the first data interface module 114, and the first data interface module 117 are each configured to perform data transmission with the second data interface module 121 through the buffer module 130. The first data interface module 112, the first data interface module 115, and the first data interface module 118 are each configured to perform data transmission with the second data interface module 122 through the buffer module 130. The first data interface module 113 and the first data interface module 116 are each configured to perform data transmission with the second data interface module 123 through the buffer module 130.

By way of example, the method for implementing out-of-band bridging in the FPGA includes performing data transmission between the first data interface modules 110 (including the first data interface module 111, the first data interface module 112, the first data interface module 113, the first data interface module 114, the first data interface module 115, the first data interface module 116, the first data interface module 117, and the first data interface module 118) and the in-band data interface modules; storing the received data in the buffer module 130; and after receiving the buffered data sequentially transmitted by the buffer module 130, the second data interface modules 120 (including the second data interface module 121, the second data interface module 122, and the third data interface module 123) transmits the data to the management data interface modules. The second data interface module 121 receives the buffered data of the first data interface module 111, the first data interface module 114, and the first data interface module 117. The second data interface module 122 receives the buffered data of the first data interface module 112, the first data interface module 115, and the first data interface module 118. The second data interface module 123 receives the buffered data of the first data interface module 113 and the first data interface module 116.

It is to be noted that in this embodiment, by way of example, eight first data interface modules 110 and three second data interface modules 120 are illustrated and not intended to limit this disclosure. In other embodiments, the number of first data interface modules 110 and the number of second data interface modules 120 may be configured as required.

It is also be noted that in the preceding embodiments, by way of example, one second data interface module 120, such as the second data interface module 123, corresponds to two first data interface modules 110; and one second data interface module 120, such as the second data interface modules 121 and 122, corresponds to three first data interface modules 110. These examples are not intended to limit this disclosure. In other embodiments, the number of first data interface modules 110 corresponding to one second data interface module 120 may also be configured to four, five, or more as required.

In this embodiment of this disclosure, the number of first data interface modules 110 and the number of second data interface modules 120 in the FPGA are flexibly configured. When the number of pins of a single FPGA is relatively large, dozens or even hundreds of first data interface modules may be configured. Therefore, under allowable conditions, a relatively large number of first data interface modules 110 and a relatively large number of second data interface modules 120 may be configured.

In related embodiments for implementing out-of-band bridging, the function of out-of-band bridging is achieved by stacking an interface chip and a microprocessor chip. In this case, a single interface chip enables connection of only a few interfaces, resulting in a large number of peripheral devices for implementing out-of-band bridging. Moreover, as the number of in-band computing units increases, the number of peripheral devices increases exponentially, leading to high costs. It can be seen that the function of out-of-band bridging implemented by the FPGA in this disclosure can reduce the number of peripheral devices, thereby lowering the costs. The more the first data interface modules 110 in the FPGA, the greater the cost reduction.

In addition, in the related embodiments implementing out-of-band bridging, some data transmission functions may be limited by buffering and link quality, thereby resulting in a simplification of certain functions. For example, for the universal asynchronous receiver-transmitter (UART) interface type, UART data is concurrent, that is, data is sent simultaneously; therefore, an additional chip with buffering function needs to be configured in the out-of-band bridging. When the density of computing units exceeds a certain number, the buffering requirements increase accordingly, making UART impossible to implement in out-of-band bridging. Similarly, for the universal serial bus (USB) interface type, USB data requires a complex link and stacking of interface chips, resulting in poor link quality. When the density of computing units exceeds a certain number, the excessive stacking layers prevent implementation of out-of-band bridging of USB. In this embodiment of this disclosure, it is feasible to implement out-of-band bridging through the FPGA by using the internal buffer module 130 without relying on device stacking, thereby enabling data transmission for both UART and USB.

Furthermore, the implementation of the function of out-of-band bridging does not impose high performance requirements on the FPGA device, allowing a wide range of applicable models and types and thus facilitating cost reduction.

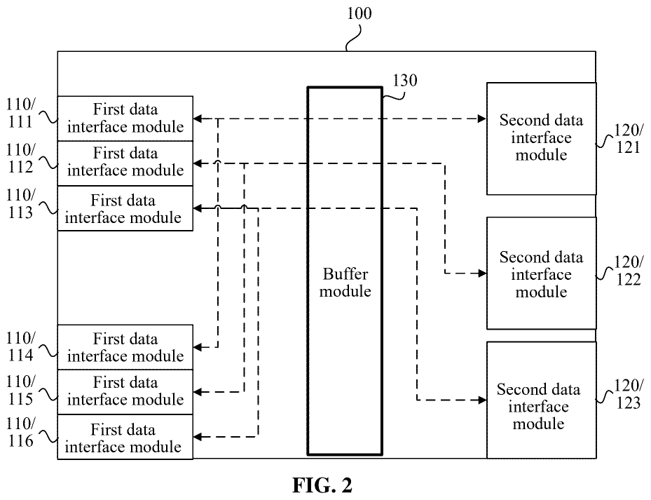

FIG. 2 is a diagram illustrating the functional structure of an FPGA structure for implementing out-of-band bridging according to an embodiment of this disclosure. Referring to FIG. 2, in an embodiment, optionally, the first data interface modules 110 are divided into at least two data interface groups. Each data interface group includes at least two types of first data interface modules 110. Each data interface group is configured to match the in-band data interface module of one computing unit in the array server. By way of example, the first data interface module 111, the first data interface module 112, and the first data interface module 113 form one data interface group. This data interface group is matched to one computing unit to implement out-of-band bridging for the computing unit. The first data interface module 114, the first data interface module 115, and the first data interface module 116 form another data interface group. This data interface group is matched to another computing unit to implement out-of-band bridging for the other computing unit.

In this disclosure, based on grouping the first data interface modules 110 to match respective computing units, the logic within the FPGA becomes clearer, simplifying the program design complexity.

In an embodiment, optionally, the computing unit of the array server includes a system-on-chip (SoC) computing unit. The SoC computing unit can be flexibly used in combination or separately according to application requirements. The FPGA for implementing out-of-band bridging according to this disclosure also offers flexible application, making it suitable for the SoC computing unit.

With continued reference to FIG. 2, in an embodiment, optionally, the number of second data interface modules 120 is the same as the number of types of the first data interface modules 110. One second data interface module 120 corresponds to one type of first data interface module 110. By way of example, the type of the first data interface module 111, the type of the first data interface module 112, and the type of the first data interface module 113 in one data interface group are different from each other; and the type of the first data interface module 114, the type of the first data interface module 115, and the type of the first data interface module 116 in another data interface group are different from each other. The type of the first data interface module 111 is the same as the type of the first data interface module 114. The type of the first data interface module 112 is the same as the type of the first data interface module 115. The type of the first data interface module 113 is the same as the type of the first data interface module 116. That is, there are three types of first data interface modules 110 in the FPGA, and correspondingly, there are three second data interface modules 120, namely the second data interface module 121, the second data interface module 122, and the second data interface module 123. The second data interface module 121 corresponds to the first data interface modules 111 and 114 of the same type. The second data interface module 122 corresponds to the first data interface modules 112 and 115 of the same type. The second data interface module 123 corresponds to the first data interface modules 113 and 116 of the same type.

In this embodiment of this disclosure, one second data interface module 120 corresponds to one type of first data interface module 110, facilitating the packaged buffering of data of the same data type, thereby simplifying the design complexity of the FPGA.

In preceding embodiments, the types of the first data interface modules 110 are configured in various manners, for example, inter-integrated circuit (IIC), universal asynchronous receiver-transmitter (UART), universal serial bus (USB), and serial peripheral interface (SPI). Likewise, the types of the second data interface modules 120 are configured in various manners, for example, IIC, UART, USB, and SPI. The following is a detailed description not intended to limit the scope of this disclosure.

In an embodiment, optionally, the types of the first data interface modules 110 include at least one of the following: inter-integrated-circuit (IIC) slave (hereinafter referred to as IIC slave), out-of-band universal asynchronous receiver-transmitter (hereinafter referred to as out-of-band UART), or first universal serial bus (USB) physical layer (hereinafter referred to as first USB physical layer).

The IIC slave is configured to match the in-band inter-integrated-circuit (IIC) bus master (hereinafter referred to as IIC master).

The out-of-band UART is configured to match the in-band universal asynchronous receiver-transmitter (hereinafter referred to as in-band UART).

The first USB physical layer is configured to match the in-band universal serial bus device (hereinafter referred to as in-band USB device). The FPGA also includes an out-of-band USB host (hereinafter referred to as out-of-band USB host), and the out-of-band USB host is configured to manage data of at least two first USB physical layers.

IIC is a serial communication bus that uses a master-slave architecture and enables acquisition of system information or basic information of the computing unit. In some embodiments, an IIC master is configured in the computing unit, and an IIC slave is configured in the FPGA, so that master-slave matching is performed. For example, multiple IIC slaves corresponding to multiple computing units buffer the received system information or basic information of the computing units into the buffer module 130 so that the second data interface module 120 can obtain the data by polling or interrupt. This embodiment of this disclosure implements out-of-band bridging for the IIC master in the computing unit through the FPGA without stacking the interface chip and the buffer chip, thereby reducing the number of out-of-band devices and lowering the costs. Furthermore, the greater the number of computing units corresponding to the FPGA, the more significant this effect.

UART is a universal serial data bus used for asynchronous communication. UART supports bidirectional communication with full-duplex transmission and reception. UART can transmit printing and log information of the computing unit to enable real-time serial port control of the computing unit. For example, multiple out-of-band UARTs corresponding to multiple computing units buffer the received printing and log information of the computing unit into the buffer module 130 so that the second data interface module 120 can obtain the data by polling or interrupt. This embodiment of this disclosure implements out-of-band bridging for the UART in the computing unit through the FPGA without stacking the interface chip and the buffer chip, thereby reducing the number of out-of-band devices and lowering the costs. Furthermore, the greater the number of computing units corresponding to the FPGA, the more significant this effect.

USB is a serial bus standard and also a technical specification for input/output interfaces, enabling functions such as firmware updates and flashing for the computing unit through USB. USB includes both host and device interfaces. The USB host acts as the controller. The USB device is controlled. A USB physical layer (PHY) is configured between the USB host and the USB device to provide a bridge for digital and modular component interfaces. In some embodiments, the computing unit is equipped with a USB device, and the FPGA is equipped with a first USB physical layer for matching. For example, the out-of-band USB host can switch between different first USB physical layers to sequentially send firmware update information to multiple in-band USB devices corresponding to multiple computing units. This embodiment of this disclosure implements out-of-band bridging for USB in the computing unit through the FPGA without stacking the interface chip, thereby shortening the link length, avoiding design complexity caused by link issues, simplifying out-of-band bridging link design, reducing the number of out-of-band devices, and lowering the costs. Furthermore, the greater the number of computing units corresponding to the FPGA, the more significant this effect. Additionally, the switching function of the out-of-band USB host enables sequential data transmission to the first USB physical layers, saving the FPGA logical resources.

In an embodiment, optionally, the types of the second data interface modules 120 include an SPI slave configured to match a management serial peripheral interface (SPI) master (hereinafter referred to as SPI master) and a second universal serial bus (USB) physical layer (hereinafter referred to as second USB physical layer).

One SPI slave is configured to perform data transmission with each IIC slave; and/or one SPI slave is configured to perform data transmission with each out-of-band UART.

The second USB physical layer is configured to match a management universal serial bus host (hereinafter referred to as management USB host). The FPGA also includes an out-of-band universal serial bus device (hereinafter referred to as out-of-band USB device), and the out-of-band USB device and the second USB physical layer serve as a transmission medium between the out-of-band USB host and the management USB host.

SPI is a high-speed, full-duplex, synchronous communication bus that enables the controller to communicate and exchange data with various peripheral devices in a serial manner. In some embodiments, the SPI master is configured in the management controller, and an SPI slave is configured in the FPGA, so that host-slave matching is performed. For example, the SPI slave acquires IIC data or UART data buffered in the buffer module 130 by polling or interrupt. This embodiment of this disclosure uses the FPGA to implement the function of out-of-band bridging for the SPI master in the management controller without stacking the interface chip and the buffer chip, thereby reducing the number of out-of-band devices and lowering the costs.

Corresponding to the configuration of the first USB physical layer and the out-of-band USB host, the functions of the second USB physical layer and the out-of-band USB device are as follows: The second USB physical layer matches the management USB host in the management controller and serves as an interface bridge between the management USB host and the out-of-band USB device. This embodiment of this disclosure uses the FPGA to implement the function of out-of-band bridging for the USB in the management controller without stacking the interface chip, thereby shortening the link length, avoiding the design complexity caused by link issues, simplifying the link design of the out-of-band bridging, reducing the number of out-of-band devices, and lowering the costs.

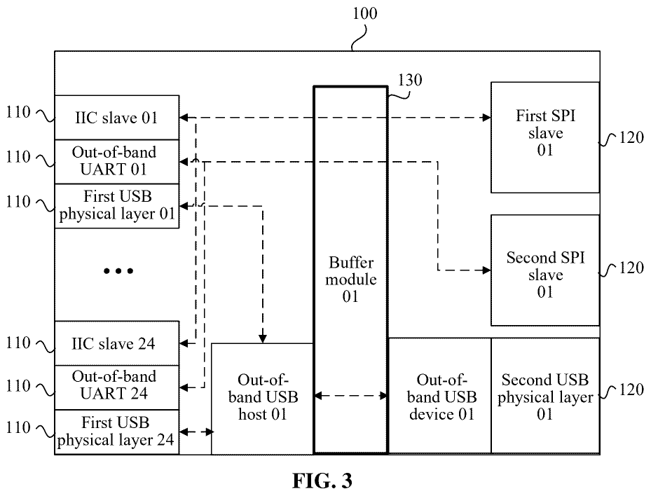

FIG. 3 is a diagram illustrating the functional structure of an FPGA structure for implementing out-of-band bridging according to an embodiment of this disclosure. Referring to FIG. 3, in an embodiment, optionally, the FPGA corresponds to 24 computing units. The first data interface modules 110 corresponding to the first computing unit are IIC slave 01, out-of-band UART 01, and first USB physical layer 01; . . . ; and the first data interface modules 110 corresponding to the 24th computing unit are IIC slave 24, out-of-band UART 24, and first USB physical layer 24. The second data interface modules 120 corresponding to the management controller are first SPI slave 01, second SPI slave 01, and second USB physical layer 01. The FPGA also includes out-of-band USB host 01 and out-of-band USB device 01.

By way of example, the 24 IIC slaves corresponding to the first through the 24th computing units (including IIC slave 01 to IIC slave 24) buffer the system information or basic information received from the 24 computing units into the buffer module 130 so that the first SPI slave can obtain the data by polling or interrupt and then transmit the data to the management controller. The 24 out-of-band UARTs (including out-of-band UART 01 to out-of-band UART 24) corresponding to the first through the 24th computing units buffer the printing, log, and other information received from the 24 computing units into the buffer module 130 so that the second SPI slave can obtain the data by polling or interrupt and then transmit the data to the management controller.

The management controller transmits data to out-of-band USB device 01 through second USB physical layer 01 and buffers the data into the buffer module 130. The out-of-band USB host obtains the data from the buffer module 130 and can switch to different first USB physical layers (including first USB physical layer 01 to first USB physical layer 24) to sequentially transmit the firmware update information to the first through the 24th computing units.

In this embodiment of this disclosure, out-of-band bridging is implemented through the FPGA. First, the data transmission of multiple IICs, multiple UARTs, and multiple USBs can be performed in a single FPGA, eliminating the need for interface chip stacking and thereby reducing the number and costs of out-of-band devices. Second, the FPGA has sufficient buffer capacity, and the single-chip design shortens the link length, facilitating the simultaneous implementation of IIC, UART, USB, and other functions. Third, by using an FPGA equipped with a USB host and a USB physical layer, there is no need for an external USB physical layer chip. Moreover, the internal switching function of the FPGA enables the USB host to sequentially connect to multiple first USB physical layers, significantly saving the FPGA logic resources.

Optionally, based on the preceding embodiments, the buffer module 130 is further configured to transparently transmit the data of first data interface modules 110 and the data of second data interface modules 120. The term “transparently transmit” refers to the transmission of data not parsed or processed by intermediate devices, facilitating preserving data integrity and enabling fast data transmission. This embodiment of this disclosure implements out-of-band bridging through the FPGA, enabling data transmission for multiple computing units within a single FPGA, thereby facilitating data transparent transmission. Therefore, this embodiment of this disclosure better improves the data transmission quality of out-of-band bridging.

This embodiment of this disclosure also provides an out-of-band bridging system. The out-of-band bridging system includes at least two FPGAs of any embodiment of this disclosure and achieves corresponding beneficial effects.

For example, in some embodiments, the array server (especially an SoC array server or another array server with the same architecture as an SoC array server) includes a large number of computing units. A single FPGA is insufficient to satisfy the out-of-band bridging requirements. In this case, multiple FPGAs, when provided, can satisfy the out-of-band bridging requirements.

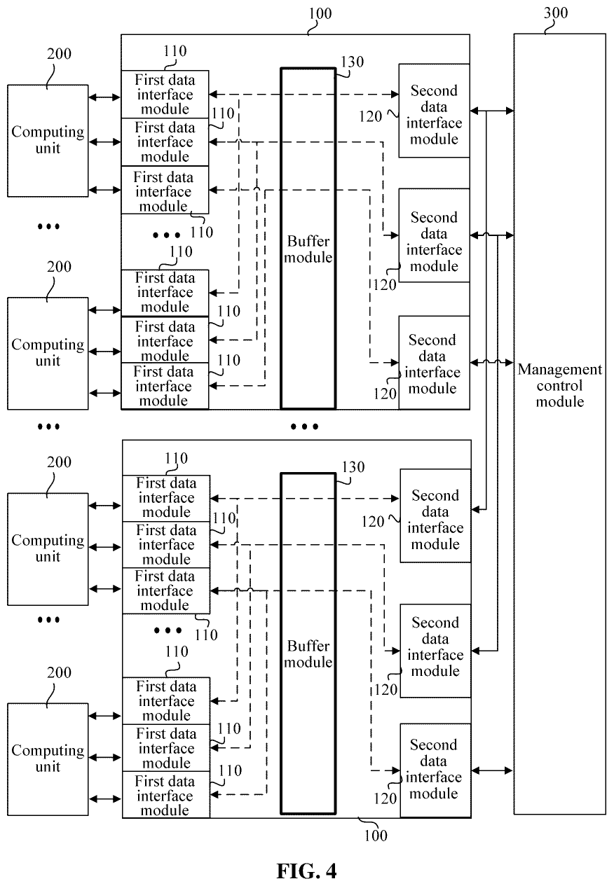

This embodiment of this disclosure also provides an array server. The array server may be an SoC array server or another array server with the same architecture as an SoC array server. FIG. 4 is a diagram illustrating the structure of an array server according to an embodiment of this disclosure. As shown in FIG. 4, the array server includes a management controller 300, the FPGA 100 of any embodiment of this disclosure, and at least two computing units 200. The FPGA 100 is configured to bridge the management controller 300 and the computing units 200. Since the array server includes the FPGA 100 of any embodiment of this disclosure and thus has similar technical principles and resulting effects.

Optionally, the management controller 300 may be a baseboard management controller (BMC).

In some embodiments, optionally, the array server also includes a switch. The switch and the computing units 200 constitute the in-band part of the array server. The FPGA 100 serves as the out-of-band bridging part. The management controller 300 serves as the out-of-band management part.

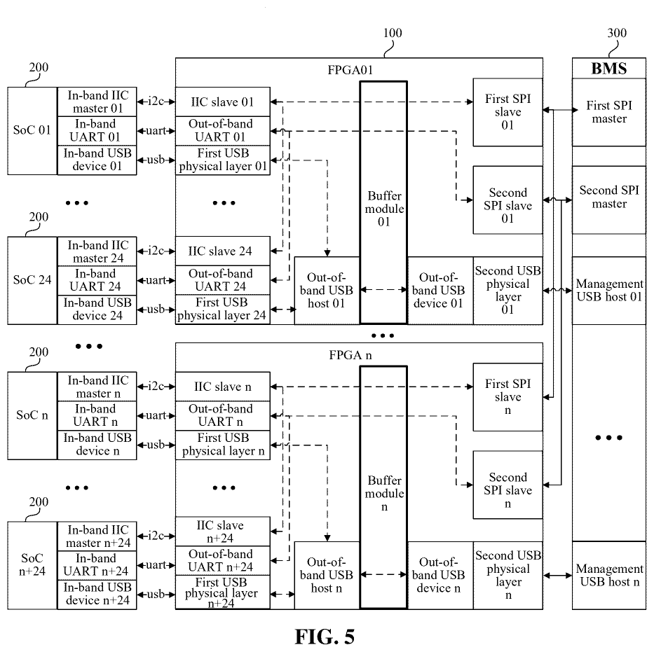

FIG. 5 is a diagram illustrating the structure of an array server according to an embodiment of this disclosure. Referring to FIG. 5, in some embodiments, optionally, at least two computing units 200 form an n-row m-column array. At least two FPGAs 100 are provided. One FPGA 100 is connected to one row or one column of computing units 200. Each FPGA 100 is connected to the management controller 300. By way of example, one FPGA 100 is connected to one row of computing units 200, and n FPGAs are provided in the array server. The number of columns (m) of the computing units 200 in one row of computing units 200 can be set as required. As shown in FIG. 5, the number of columns (m) in one row of computing units 200 is 24, meaning one FPGA corresponds to 24 computing units 200.

In some embodiments, optionally, the first data interface modules in each FPGA are divided into at least two data interface groups. One computing unit 200 corresponds to one data interface group. As shown in FIG. 5, using FPGA 01 as an example, the first data interface modules include IIC slave 01, out-of-band UART 01, first USB physical layer 01, . . . , IIC slave 24, out-of-band UART 24, and first USB physical layer 24. IIC slave 01, out-of-band UART 01, and first USB physical layer 01 constitute the first data interface group. The first data interface group corresponds to the computing unit 200 located in row 1, column 1; . . . IIC slave 24, out-of-band UART 24, and first USB physical layer 24 constitute the 24th data interface group. The 24th data interface group corresponds to the computing unit 200 located in row 1, column 24. Similarly, using FPGA n as an example, the first data interface modules include IIC slave n, out-of-band UART n, first USB physical layer n, . . . , IIC slave n+24, out-of-band UART n+24, and first USB physical layer n+24. IIC slave n, out-of-band UART n, and first USB physical layer n constitute the first data interface group. The first data interface group corresponds to the computing unit 200 located in row n, column 1; . . . IIC slave n+24, out-of-band UART n+24, and first USB physical layer n+24 constitute the 24th data interface group. The 24th data interface group corresponds to the computing unit 200 located in row n, column 24. This embodiment of this disclosure groups the first data interface modules to match the computing units, thereby clarifying the logic within the FPGA and facilitating simplification of program design complexity.

In an embodiment, optionally, the computing unit 200 includes an SoC computing unit. The SoC computing unit can be flexibly used in combination or separately according to application requirements.

In an embodiment of this disclosure, optionally, the in-band data interface modules of a computing unit 200 include at least two types, the first data interface modules also include at least two types, the number of second data interface modules is equal to the number of types of first data interface modules, and one second data interface module corresponds to one type of first data interface module. This embodiment of this disclosure enables data of the same type to be buffered in packets by configuring one second data interface module to correspond to one type of first data interface module, thereby simplifying the FPGA design complexity.

In an embodiment of this disclosure, optionally, the in-band data interface modules of the computing unit 200 include at least one of an IIC master, an in-band UART, or an in-band USB device; and/or the management data interface modules of the management controller 300 include a first management SPI master, a second management SPI master, and at least two management USB hosts.

In an embodiment of this disclosure, optionally, the first data interface modules 110 of the FPGA 100 include IIC slaves, and the IIC slaves are connected to the IIC masters in a one-to-one correspondence; and/or the first data interface modules 110 of the FPGA 100 include out-of-band UARTs, and the out-of-band UARTs are connected to the corresponding in-band UARTs in a one-to-one correspondence; and/or the first data interface modules 110 of the FPGA 100 include first USB physical layers, the FPGA 100 further includes an out-of-band USB host, and the first USB physical layers are connected to the corresponding in-band USB devices in a one-to-one correspondence; and the first USB physical layers are connected to the out-of-band USB hosts, and the out-of-band USB hosts are configured to switch data transmission at different first USB physical layers.

In an embodiment of this disclosure, optionally, the second data interface module 120 of the FPGA 100 includes a first SPI slave, and the first SPI slave of each FPGA 100 is connected to the first management SPI master; and/or the second data interface module 120 of the FPGA 100 include a second SPI slave, and the second SPI slave of each FPGA 100 is connected to the second management SPI master; and/or the second data interface modules 120 of the FPGA 100 include a second USB physical layer, the FPGA 100 also includes an out-of-band USB device, the second USB physical layer is connected to the management USB master in a one-to-one correspondence, and the second USB physical layer serves as a transmission medium between the out-of-band USB device and the management USB master.

In an embodiment of this disclosure, optionally, the first data interface modules 110 of FPGA 100 include IIC slaves, out-of-band UARTs, and first USB physical layers; the second data interface modules 120 of FPGA 100 include first SPI slaves, second SPI slaves, and second USB physical layers; FPGA 100 also includes an out-of-band USB host and an out-of-band USB device; in each FPGA 100, each IIC slave is connected to the first SPI slave through the buffer module 130; each out-of-band UART is connected to the second SPI slave through the buffer module 130; and each first USB physical layer is connected to the out-of-band USB host, the out-of-band USB host is connected to the out-of-band USB device through the buffer module 130, and the out-of-band USB device is connected to the second USB physical layer.

As shown in FIG. 5, by way of example, the computing units 200 include three types: IIC, UART, and USB, and the management controller 300 includes two types: SPI and USB. Computing unit SoC 01 includes in-band IIC master 01, in-band UART 01, and in-band USB device 01; . . . ; computing unit SoC 24 includes in-band IIC master 24, in-band UART 24, and in-band USB device 24; . . . ; computing unit SoC n includes in-band IIC master n, in-band UART n, and in-band USB device n; . . . ; computing unit SoC n+24 includes in-band IIC master n+24, in-band UART n+24, and in-band USB device n+24. The management controller 300 includes a first SPI master, a second SPI master, management USB host 01, . . . , and management USB host n.

Correspondingly, the first data interface modules in FPGA 01 are IIC slave 01, out-of-band UART 01, and first USB physical layer 01; . . . ; the first data interface modules corresponding to the 24th computing unit are IIC slave 24, out-of-band UART 24, and first USB physical layer 24; and the second data interface modules are first SPI slave 01, second SPI slave 01, and second USB physical layer 01. FPGA 01 also includes out-of-band USB host 01 and out-of-band USB device 01. FPGA 01 corresponds to the 24 SoCs in the first row.

By analogy, the first data interface modules in FPGA n are IIC slave n, out-of-band UART n, and first USB physical layer n; . . . ; the first data interface modules corresponding to the 24th computing unit are IIC slave n+24, out-of-band UART n+24, and first USB physical layer n+24; and the second data interface modules are first SPI slave n, second SPI slave n, and second USB physical layer n. FPGA n also includes out-of-band USB host n and out-of-band USB device n. FPGA n corresponds to the 24 SoCs in the nth row.

First SPI slave Olin FPGA 01 through first SPI slave n in FPGA n are all connected to the first SPI master in the management controller 300. Second SPI slave 01 in FPGA 01 through second SPI slave n in FPGA n are all connected to the second SPI master in the management controller 300.

Second USB physical layer 01 in FPGA 01 is connected to management USB host 01 in the management controller 300, . . . Second USB physical layer n in FPGA n is connected to management USB host n in the management controller 300.

By way of example, the 24 IIC slaves (including IIC slave 01 to IIC slave 24) corresponding to the 24 computing units in the first row buffer the system information or basic information received from the 24 computing units into buffer module 01, . . . The 24 IIC slaves (including IIC slave n to IIC slave n+24) corresponding to the 24 computing units in the nth row buffer the system information or basic information received from the 24 computing units in the first row into buffer module n. The first SPI master in the management controller 300 controls first SPI slave 01 to first SPI slave n to obtain data by polling or interrupt and then transmits the data to the management controller 300.

By way of example, the 24 out-of-band UARTs (including out-of-band UART 01 to out-of-band UART 24) corresponding to the 24 computing units in the first row buffer the received printing, log, and other information of the 24 computing units into buffer module 01; . . . The 24 out-of-band UARTs (including out-of-band UART n to out-of-band UART n+24) corresponding to the 24 computing units in the nth row buffer the received printing, log, and other information of the 24 computing units in the first row into buffer module n. The second SPI master in the management controller 300 controls second SPI slave 01 to second SPI slave n to obtain data by polling or interrupt and then transmits the data to the management controller 300.

The management controller 300 transmits data to FPGA 01 through management USB host 01. In FPGA 01, second USB physical layer 01 transmits data to out-of-band USB device 01 and buffers the data in buffer module 01. Out-of-band USB host 01 obtains the data from buffer module 01 and can switch to different first USB physical layers (including first USB physical layer 01 to first USB physical layer 24) to sequentially transmit the firmware update information to the 24 computing units 200 in the first row. The management controller 300 transmits data to FPGA n through management USB host n. In FPGA n, second USB physical layer n transmits data to out-of-band USB device n and buffers the data in buffer module n. Out-of-band USB host n obtains the data from buffer module n and can switch to different first USB physical layers (including first USB physical layer n to first USB physical layer n+24) to sequentially transmit the firmware update information to the 24 computing units 200 in the nth row.

In this embodiment of this disclosure, out-of-band bridging is implemented through the FPGA. First, the data transmission of multiple IICs, multiple UARTs, and multiple USBs can be performed in a single FPGA, eliminating the need for interface chip stacking and thereby reducing the number and costs of out-of-band devices. Second, the FPGA has sufficient buffer capacity, and the single-chip design shortens the link length, facilitating the simultaneous implementation of IIC, UART, USB, and other functions. Third, by using an FPGA equipped with a USB host and a USB physical layer, there is no need for an external USB physical layer chip. Moreover, the internal switching function of the FPGA enables the USB host to sequentially connect to multiple first USB physical layers, significantly saving the FPGA logic resources.

In preceding embodiments, the server may be a cloud server, also referred to as a cloud computing server or a cloud host. As a host product in a cloud computing service system, the server solves the defects of difficult management and weak service scalability in the service of a related physical host and a related VPS. The server may also be a server of a distributed system, or a server combined with a blockchain.

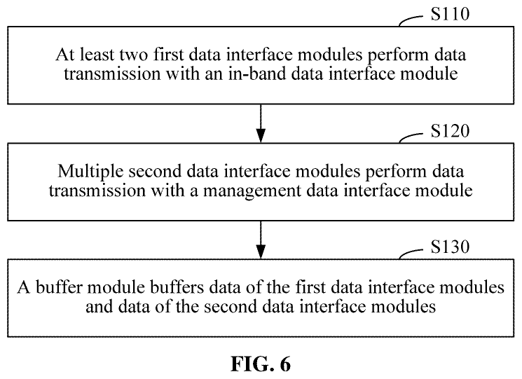

This embodiment of this disclosure also provides a method for implementing out-of-band bridging in an FPGA. The method can be performed by the FPGA of any embodiment of this disclosure to achieve corresponding beneficial effects. FIG. 6 is a flowchart of a method for implementing out-of-band bridging in an FPGA structure according to an embodiment of this disclosure. Referring to FIG. 6, the method includes the following:

In S110, at least two first data interface modules perform data transmission with an in-band data interface module.

In S120, multiple second data interface modules perform data transmission with a management data interface module.

In S130, a buffer module buffers data of the first data interface modules and data of the second data interface modules, where each of the second data interface modules is configured to perform data transmission with the at least two first data interface modules through the buffer module.

In this embodiment of this disclosure, the FPGA is provided with first data interface modules 110 for performing data transmission with in-band data interface modules, second data interface modules 120 for performing data transmission with management data interface modules, and a buffer module 130 configured to buffer data of the first data interface modules 110 and data of the second data interface modules 120 such that at least two first data interface modules 110 transmit data to the second data interface modules 120 after being buffered by the buffer module 130, thereby enabling the FPGA to implement the function of out-of-band bridging.

This embodiment of this disclosure enables bidirectional data transmission, for example, data transmission from the computing unit to the management controller, data transmission from the management controller to the computing unit, or bidirectional data transmission between the computing unit and the management controller. This is configured as required in practical application.

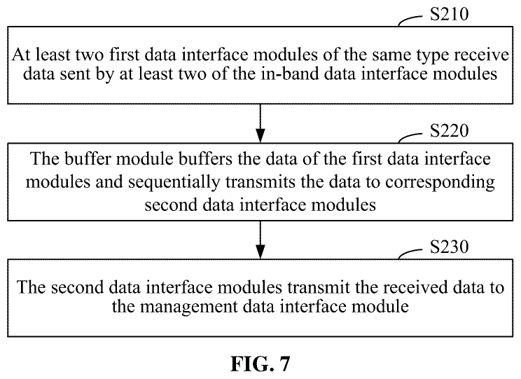

FIG. 7 is a flowchart of a method for implementing out-of-band bridging in an FPGA structure according to an embodiment of this disclosure. Referring to FIG. 7, in an embodiment, optionally, the data transmission direction is from the in-band data interface module to the management data interface module. The method includes the following:

In S210, at least two first data interface modules of the same type receive data sent by at least two of the in-band data interface modules.

In S220, the buffer module buffers the data of the first data interface modules and sequentially transmits the data to corresponding second data interface modules.

Optionally, the buffer module buffers the data of each first data interface module in the following manner: The buffer module receives data from each first data interface module either at the same time or at different times and buffers the received data. Such configuration facilitates concurrent data buffering.

In S230, the second data interface modules transmit the received data to the management data interface module.

The method is applicable to acquisition of system information, basic information, printing information, and log information of the computing units. For example, the method is applicable to the transmission of IIC data and UART data.

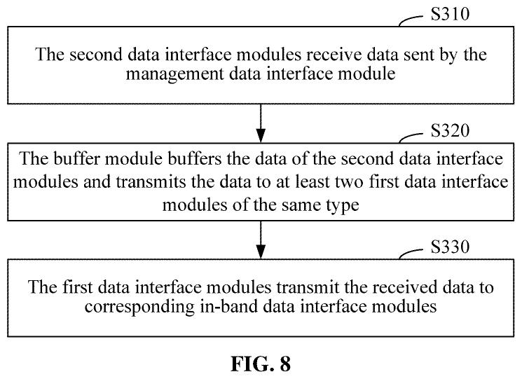

FIG. 8 is a flowchart of a method for implementing out-of-band bridging in an FPGA structure according to an embodiment of this disclosure. Referring to FIG. 8, in an embodiment, optionally, the data transmission direction is from the management data interface module to the in-band data interface module. The method includes the following:

In S310, the second data interface modules receive data sent by the management data interface module.

In S320, the buffer module buffers the data of the second data interface modules and transmits the data to at least two first data interface modules of the same type.

In S330, the first data interface modules transmit the received data to corresponding in-band data interface modules.

The method is applicable to scenarios such as firmware updates for the computing units.

For example, the method is applicable to the transmission of USB data.

In solutions of embodiments of this disclosure, operations such as data reception, transmission, sending, and buffering conform to relevant laws and regulations and do not violate the public policy doctrine.

It is to be understood that various forms of the preceding flows may be used with steps reordered, added, or removed. For example, the steps described in this disclosure may be executed in parallel, in sequence, or in a different order as long as the desired results of the technical solutions provided in this disclosure are achieved. The execution sequence of these steps is not limited herein.

The scope of this disclosure is not limited by the preceding embodiments. It is to be understood by those skilled in the art that various modifications, combinations, sub-combinations, and substitutions may be made according to design requirements and other factors. Any modification, equivalent substitution, and improvement made within the spirit and principle of this disclosure is within the scope of this disclosure.

What is claimed is:

1. A field-programmable gate array structure for implementing out-of-band bridging, comprising:
at least two first data interface modules, wherein each of the first data interface modules is matched to a respective in-band data interface module;
at least two second data interface modules, wherein each of the second data interface modules is matched to a respective management data interface module; and
a buffer module configured to buffer data of the first data interface modules and data of the second data interface modules;
wherein each of the second data interface modules is configured to perform data transmission with the at least two first data interface modules through the buffer module.

2. The field-programmable gate array structure for implementing out-of-band bridging according to claim 1, wherein the first data interface modules are divided into at least two data interface groups; and
each of the data interface groups comprises at least two types of first data interface modules, and each of the data interface groups is configured to match an in-band data interface module of a computing unit in an array server;
wherein the computing unit of the array server comprises a system-on-chip (SoC) computing unit.

3. The field-programmable gate array structure for implementing out-of-band bridging according to claim 1, wherein a number of the second data interface modules is the same as a number of types of the first data interface modules; and
one of the second data interface modules corresponds to one type of first data interface module.

4. The field-programmable gate array structure for implementing out-of-band bridging according to claim 1, wherein the at least two types of the first data interface modules comprise at least one of the following:
an inter-integrated-circuit bus slave configured to match an in-band inter-integrated-circuit bus master; or
an out-of-band universal asynchronous receiver-transmitter configured to match an in-band universal asynchronous receiver-transmitter.

5. The field-programmable gate array structure for implementing out-of-band bridging according to claim 4, wherein types of the second data interface modules comprise a serial peripheral interface slave configured to match a management serial peripheral interface master; and at least one of the following is satisfied:
one serial peripheral interface slave is configured to perform data transmission with inter-integrated-circuit bus slaves; or
one serial peripheral interface slave is configured to perform data transmission with out-of-band universal asynchronous receiver-transmitters.

6. The field-programmable gate array structure for implementing out-of-band bridging according to claim 1, wherein types of the first data interface modules comprise a first universal serial bus physical layer configured to match an in-band universal serial bus device; and
the field-programmable gate array structure further comprises an out-of-band universal serial bus host configured to manage data of at least two first universal serial bus physical layers.

7. The field-programmable gate array structure for implementing out-of-band bridging according to claim 6, wherein types of the second data interface modules comprise a second universal serial bus physical layer configured to match a management universal serial bus host; and
the field-programmable gate array structure further comprises an out-of-band universal serial bus device, and the out-of-band universal serial bus device and the second universal serial bus physical layer serve as a transmission medium between the out-of-band universal serial bus host and the management universal serial bus host.

8. The field-programmable gate array structure for implementing out-of-band bridging according to claim 1, wherein types of the second data interface modules comprise at least one of the following:
a serial peripheral interface slave configured to match a management serial peripheral interface master; or
a second universal serial bus physical layer configured to match a management universal serial bus host, wherein the field-programmable gate array structure further comprises an out-of-band universal serial bus device, and the second universal serial bus physical layer serves as a transmission medium between the out-of-band universal serial bus device and the management universal serial bus host;
wherein the buffer module is further configured to transparently transmit the data of the first data interface modules and the data of the second data interface modules.

9. An out-of-band bridging system, comprising at least two field-programmable gate array structures according to claim 1.

10. An array server, comprising a management controller, a field-programmable gate array structure, and at least two computing units; wherein the field-programmable gate array structure comprises:
at least two first data interface modules, wherein each of the first data interface modules is matched to a respective in-band data interface module;
at least two second data interface modules, wherein each of the second data interface modules is matched to a respective management data interface module; and
a buffer module configured to buffer data of the first data interface modules and data of the second data interface modules,
wherein each of the second data interface modules is configured to perform data transmission with the at least two first data interface modules through the buffer module; and
the field-programmable gate array structure is configured to bridge the management controller and the at least two computing units;
wherein the at least two computing units form an n-row m-column array; and at least two field-programmable gate array structures are provided, and among the field-programmable gate array structures, one field-programmable gate array structure is connected to one row or one column of the computing units, and each field-programmable gate array structure is connected to the management controller.

11. The array server according to claim 10, wherein the first data interface modules are divided into at least two data interface groups, and one of the computing units corresponds to one data interface group of the at least two data interface groups.

12. The array server according to claim 10, wherein a computing unit of the computing units comprises at least two types of in-band data interface modules, and the first data interface modules are of at least two types; and
a number of the second data interface modules is the same as a number of types of the first data interface modules, and one of the second data interface modules corresponds to one type of first data interface module.

13. The array server according to claim 10, wherein at least one of the following is satisfied:
in-band data interface modules of a computing unit of the computing units comprise at least one of an inter-integrated-circuit bus master, an in-band universal asynchronous receiver-transmitter, or an in-band universal serial bus device; or
management data interface modules of the management controller comprise a first management serial peripheral interface master, a second management serial peripheral interface master, and at least two management universal serial bus hosts.

14. The array server according to claim 13, wherein at least one of the following is satisfied:
the first data interface modules of the field-programmable gate array structure comprise an inter-integrated-circuit bus slave, and the inter-integrated-circuit bus slave is connected to the inter-integrated-circuit bus master in a one-to-one correspondence;
the first data interface modules of the field-programmable gate array structure comprise an out-of-band universal asynchronous receiver-transmitter, the out-of-band universal asynchronous receiver-transmitter is connected to the in-band universal asynchronous receiver-transmitter in a one-to-one correspondence; or
the first data interface modules of the field-programmable gate array structure comprise a first universal serial bus physical layer, the field-programmable gate array structure further comprises an out-of-band universal serial bus host, and the first universal serial bus physical layer is connected to the in-band universal serial bus device in a one-to-one correspondence; and the first universal serial bus physical layer is connected to an out-of-band universal serial bus host, and the out-of-band universal serial bus host is configured to switch data transmission at different first universal serial bus physical layers.

15. The array server according to claim 13, wherein at least one of the following is satisfied:
the second data interface modules of the field-programmable gate array structure comprise a first serial peripheral interface slave, and a first serial peripheral interface slave of each field-programmable gate array structure is connected to the first management serial peripheral interface master;
the second data interface modules of the field-programmable gate array structure comprise a second serial peripheral interface slave, and a second serial peripheral interface slave of each field-programmable gate array structure is connected to the second management serial peripheral interface master; or
the second data interface modules of the field-programmable gate array structure comprise a second universal serial bus physical layer, the field-programmable gate array structure further comprises an out-of-band universal serial bus device, the second universal serial bus physical layer is connected to a management universal serial bus host of the at least two management universal serial bus hosts in a one-to-one correspondence, and the second universal serial bus physical layer serves as a transmission medium between the out-of-band universal serial bus device and the management universal serial bus host.

16. The array server according to claim 13, wherein the first data interface modules of the field-programmable gate array structure comprise an inter-integrated-circuit bus slave, an out-of-band universal asynchronous receiver-transmitter, and a first universal serial bus physical layer; and the second data interface modules of the field-programmable gate array structure comprise a first serial peripheral interface slave, a second serial peripheral interface slave, and a second universal serial bus physical layer;
the field-programmable gate array structure further comprises an out-of-band universal serial bus host and an out-of-band universal serial bus device; and
within the field-programmable gate array structure, each inter-integrated-circuit bus slave is connected to the first serial peripheral interface slave through the buffer module, each out-of-band universal asynchronous receiver-transmitter is connected to the second serial peripheral interface slave through the buffer module, each first universal serial bus physical layer is connected to the out-of-band universal serial bus host, the out-of-band universal serial bus host is connected to the out-of-band universal serial bus device through the buffer module, and the out-of-band universal serial bus device is connected to the second universal serial bus physical layer.

17. A method for implementing out-of-band bridging in a field-programmable gate array structure, comprising:
performing, by at least two first data interface modules, data transmission with in-band data interface modules;
performing, by a plurality of second data interface modules, data transmission with a management data interface module; and
buffering, by a buffer module, data of the first data interface modules and data of the second data interface modules;
wherein each of the second data interface modules is configured to perform data transmission with the at least two first data interface modules through the buffer module.

18. The method for implementing out-of-band bridging in a field-programmable gate array structure according to claim 17, wherein a data transmission direction is from the in-band data interface modules to the management data interface module, and the method comprises:
receiving, by at least two the first data interface modules of a same type, data sent by at least two of the in-band data interface modules;
buffering, by the buffer module, the data of the first data interface modules and sequentially
transmitting the data to corresponding second data interface modules; and
transmitting, by the second data interface modules, the received data to the management data interface module;
wherein buffering, by the buffer module, the data of the first data interface modules comprises: simultaneously receiving, by the buffer module, the data of the first data interface modules and buffering the received data.

19. The method for implementing out-of-band bridging in a field-programmable gate array structure according to claim 18, wherein the method is applicable to transmission of data of an inter-integrated-circuit bus and data of a universal asynchronous receiver-transmitter.

20. The method for implementing out-of-band bridging in a field-programmable gate array structure according to claim 17, wherein a data transmission direction is from the management data interface module to the in-band data interface modules, and the method comprises:
receiving, by the second data interface modules, data sent by the management data interface module;
buffering, by the buffer module, the data of the second data interface modules and transmitting the data to at least two first data interface modules of a same type; and
transmitting, by the first data interface modules, the received data to corresponding in-band data interface modules;
wherein the method is applicable to transmission of data of a universal serial bus.
